(19) United States
(12) Patent Application Publication
(10) Pub. No.: US 2016/0204841 A1
(43) Pub. Date: Jul. 14, 2016

(54) FEEDBACK INFORMATION REPORTING METHOD AND APPARATUS IN WIRELESS COMMUNICATION SYSTEM

(71) Applicant: LG ELECTRONICS INC., Seoul (KR)

(72) Inventors: Hyungtae KIM, Seoul (KR); Kijun KIM, Seoul (KR); Jonghyun PARK, Seoul (KR)

(73) Assignee: LG ELECTRONICS INC., Seoul (KR)

(21) Appl. No.: 14/913,943

(22) PCT Filed: Oct. 20, 2014
(86) PCT No.: PCT/KR2014/009830

§ 371 Date: Feb. 23, 2016

Related U.S. Application Data
(60) Provisional application No. 61/893,852, filed on Oct. 21, 2013.

(51) Int. Cl. H04B 7/04; H04W 72/00; H04W 4/06; H04B 7/06

(52) U.S. Cl. CPC H04B 7/0417; H04B 7/0632; H04B 7/0626; H04W 72/005; H04W 4/06; H04L 12/189

(57) ABSTRACT

The present invention relates to a wireless communication system. A method for reporting feedback information of multicast broadcast multimedia services (MBSFN) transmission in a wireless communication system according to an embodiment of the present invention, which comprises the steps of: receiving configuration information for feedback information on the MBSFN transmission; and transmitting the feedback information measured in the resource area according to the configured information, wherein the feedback information can include a single MSFN change quality indicator (CQI) generated using the M (M≧2) number of MB SFN channel state information (CSI) reference resources.

### TECHNICAL FIELD

The present invention relates to a wireless communication system, and more particularly, to a method and apparatus for reporting feedback information, by which a user equipment receives configuration information for feedback information of MBSFN transmission and transmits the feedback information of the MBSFN transmission measured in a resource region according to the configured information.

### BACKGROUND ART

Multiple input multiple output (MIMO) increases the efficiency of data transmission and reception using multiple transmit antennas and multiple receive antennas instead of a single transmission antenna and a single reception antenna. A receiver receives data through multiple paths when multiple antennas are used, whereas the receiver receives data through a single antenna path when a single antenna is used. Accordingly, MIMO can increase a data transmission rate and throughput and improve coverage.

A single cell MIMO scheme can be classified into a single user-MIMO (SU-MIMO) scheme for receiving a downlink signal by a single UE in one cell and a multi user-MIMO (MU-MIMO) scheme for receiving a downlink signal by two or more UEs.

Research on coordinated multi-point (CoMP) for improving throughput of a UE located at a cell boundary by applying improved MIMO to a multi-cell environment is actively performed. The CoMP system can decrease inter-cell interference in a multi-cell environment and improve system performance.

Channel estimation refers to a procedure for compensating for signal distortion due to fading to restore a reception signal. Here, the fading refers to sudden fluctuation in signal intensity due to multipath-time delay in a wireless communication system environment. For channel estimation, a reference signal (RS) known to both a transmitter and a receiver is required. In addition, the RS can be referred to as a RS or a pilot signal according to applied standard.

A downlink RS is a pilot signal for coherent demodulation for a physical downlink shared channel (PDSCH), a physical control format indicator channel (PCFICH), a physical hybrid indicator channel (PHICH), a physical downlink control channel (PDCCH), etc. A downlink RS includes a common RS (CRS) shared by all user equipments (UEs) in a cell and a dedicated RS (DRS) for a specific UE. For a system (e.g., a system having extended antenna configuration LTE-A standard for supporting 8 transmission antennas) compared with a conventional communication system (e.g., a system according to LTE release-8 or 9) for supporting 4 transmission antennas, DRS based data demodulation has been considered for effectively managing RSs and supporting a developed transmission scheme. That is, for supporting data transmission through extended antennas, DRS for two or more layers can be defined. DRS is pre-coded by the same pre-coder as a pre-coder for data and thus a receiver can easily estimate channel information for data demodulation without separate precoding information.

A downlink receiver can acquire pre-coded channel information for extended antenna configuration through DRS but requires a separate RS other than DRS in order to non-pre-coded channel information. Accordingly, a receiver of a system according to LTE-A standard can define a RS for acquisition of channel state information (CSI), that is, CSI-RS.

### DISCLOSURE OF THE INVENTION

### Technical Task

Based on the aforementioned discussion, an object of the present invention is to provide a method and device for transmitting and receiving channel state information in a wireless communication system.

Another technical task of the present invention is to provide a method for a user equipment to receive configuration information for feedback information of MBSFN transmission and to transmit the feedback information of the MBSFN transmission measured in a resource region according to the configured information.

Technical tasks obtainable from the present invention are non-limited by the above-mentioned technical tasks. And, other unmentioned technical tasks can be clearly understood from the following description by those having ordinary skill in the technical field to which the present invention pertains.

### Technical Solutions

In a 1^{st} technical aspect of the present invention, provided herein is a method of reporting feedback information of MBSFN (multicast broadcast multimedia services) transmission in a wireless communication system, including the steps of receiving configuration information for the feedback information of the MBSFN transmission and transmitting the feedback information measured in a resource region according to the configuration information. The feedback information may include one MBSFN CQI (channel quality indicator) generated based on M (M≧2) MBSFN CSI (channel state information) reference resources.

In a 2^{nd} technical aspect of the present invention, provided herein is a user equipment configured to report feedback information of MBSFN (multicast broadcast multimedia services) transmission in a wireless communication system, including an RF (radio frequency) unit and a processor. The processor is configured to receive configuration information for the feedback information of the MBSFN transmission and to transmit the feedback information measured in a resource region according to the configuration information. The feedback information may include one MBSFN CQI (channel quality indicator) generated based on M (M≧2) MBSFN CSI (channel state information) reference resources.

The following matters may be included in the 1^{st} and 2^{nd} technical aspects of the present invention.

The MBSFN CQI may be calculated based on whether a transport block error probability with respect to each resource included in the M MBSFN CSI reference resources is equal to or less than a reference.

The MBSFN CQI may be calculated on an assumption that control signals are transmitted in first 2 symbols of M downlink subframes corresponding to the M MBSFN CSI reference resources and there is no resource element allocated for a PRS (positioning reference signal).

The MBSFN CQI may be reported if a difference value between the MBSFN CQI and a previously calculated MBSFN CQI is equal to or greater than a reference value.

The MBSFN CQI may be calculated in a subframe spaced apart more than a prescribed number of subframes from an MBSFN CSI reference resource of an immediately previously reported MBSFN CQI.

The MBSFN CQI may be configured to indicate a difference value between the MBSFN CQI and an immediately previously reported MBSFN CQI.

Information on the M may be received from a base station through RRC (radio resource control) signaling.

Effects obtainable from the present invention are non-limited by the above mentioned effects. And, other unmentioned effects can be clearly understood from the following description by those having ordinary skill in the technical field to which the present invention pertains.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating an example of a structure of a downlink radio frame.

FIG. 2 is a diagram illustrating an example of a resource grid for one downlink slot.

FIG. 3 is a diagram illustrating a structure of a downlink subframe.

FIG. 4 is a diagram illustrating a structure of an uplink subframe.

FIG. 5 is a schematic diagram illustrating a wireless communication system having multiple antennas.

FIG. 6 is a diagram illustrating legacy CRS and DRS patterns.

FIG. 7 is a diagram illustrating an example of a DM RS pattern.

FIG. 8 is a diagram illustrating examples of a CSI-RS pattern.

FIG. 9 is a diagram for an example of a ZP (zero power) CSI-RS pattern.

FIG. 10 is a diagram for one example of performing CoMP.

FIG. 11 is a diagram to describe mapping of an MBSFN reference signal in case of extended CP.

FIG. 12 is a flowchart of a feedback reporting method applicable to one embodiment of the present invention.

FIG. 13 is a diagram for examples of a base station and a user equipment applicable to one embodiment of the present invention.

### BEST MODE FOR INVENTION

The embodiments described below correspond to predetermined combinations of elements and features and characteristics of the present invention. Moreover, unless mentioned otherwise, the characteristics of the present invention may be considered as optional features of the present invention. Herein, each element or characteristic of the present invention may also be operated or performed without being combined with other elements or characteristics of the present invention. Alternatively, the embodiment of the present invention may be realized by combining some of the elements and/or characteristics of the present invention. Additionally, the order of operations described according to the embodiment of the present invention may be varied. Furthermore, part of the configuration or characteristics of any one specific embodiment of the present invention may also be included in (or shared by) another embodiment of the present invention, or part of the configuration or characteristics of any one embodiment of the present invention may replace the respective configuration or characteristics of another embodiment of the present invention.

In the description of the present invention, the embodiments of the present invention will be described by mainly focusing on the data transmission and reception relation between a base station and a user equipment. Herein, the base station may refer to a terminal node of the network that performs direct communication with the user equipment (or user terminal). In the description of the present invention, particular operations of the present invention that are described as being performed by the base station may also be performed by an upper node of the base station.

More specifically, in a network consisting of multiple network nodes including the base station, diverse operations that are performed in order to communicate with the terminal (or user equipment) may be performed by the base station or network nodes other than the base station. Herein, the term ‘Base Station (BS)’ may be replaced by other terms, such as fixed station, Node B, eNode B (eNB), ABS (Advanced Base Station), or Access Point (AP). Relay may be replaced by other terms, such as Relay Node (RN), Relay Station (RS), and so on. Furthermore, ‘Terminal’ may be replaced by other terms, such as UE (User Equipment), MS (Mobile Station), MSS (Mobile Subscriber Station), SS (Subscriber Station), and so on.

It should be noted that specific terms disclosed in the present invention are proposed for convenience of description and better understanding of the present invention, and the use of these specific terms may be changed to other formats within the technical scope or spirit of the present invention.

In some instances, well-known structures and devices are omitted in order to avoid obscuring the concepts of the present invention and important functions of the structures and devices are shown in block diagram form. The same reference numbers will be used throughout the drawings to refer to the same or like parts.

Exemplary embodiments of the present invention are supported by standard documents disclosed for at least one of wireless access systems including an institute of electrical and electronics engineers (IEEE) 802 system, a 3rd generation partnership project (3GPP) system, a 3GPP long term evolution (LTE) system, an LTE-advanced (LTE-A) system, and a 3GPP2 system. In particular, steps or parts, which are not described to clearly reveal the technical idea of the present invention, in the embodiments of the present invention may be supported by the above documents. All terminology used herein may be supported by at least one of the above-mentioned documents.

The following embodiments of the present invention can be applied to a variety of wireless access technologies, for example, code division multiple access (CDMA), frequency division multiple access (FDMA), time division multiple access (TDMA), orthogonal frequency division multiple access (OFDMA), single carrier frequency division multiple access (SC-FDMA), and the like. CDMA may be embodied through wireless (or radio) technology such as universal terrestrial radio access (UTRA) or CDMA2000. TDMA may be embodied through wireless (or radio) technology such as global system for mobile communication (GSM)/general packet radio service (GPRS)/enhanced data rates for GSM evolution (EDGE). OFDMA may be embodied through wireless (or radio) technology such as institute of electrical and electronics engineers (IEEE) 802.11 (Wi-Fi), IEEE 802.16 (WiMAX), IEEE 802-20, and evolved UTRA (E-UTRA). UTRA is a part of universal mobile telecommunications system (UMTS). 3rd generation partnership project (3GPP) long term evolution (LTE) is a part of E-UMTS (Evolved UMTS), which uses E-UTRA. 3GPP LTE employs OFDMA in downlink and employs SC-FDMA in uplink. LTE-Advanced (LTE-A) is an evolved version of 3GPP LTE. WiMAX can be explained by IEEE 802.16e (wirelessMAN-OFDMA reference system) and advanced IEEE 802.16m (wirelessMAN-OFDMA advanced system). For clarity, the following description focuses on IEEE 802.11 systems. However, technical features of the present invention are not limited thereto.

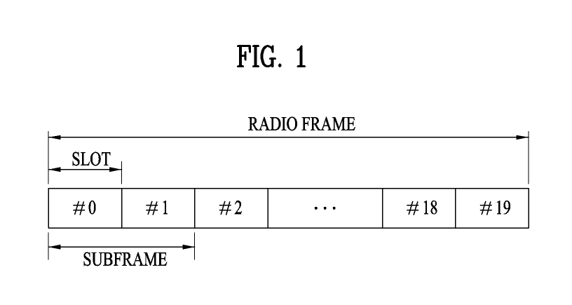

With reference to FIG. 1, the structure of a downlink radio frame will be described below.

In a cellular orthogonal frequency division multiplexing (OFDM) wireless packet communication system, uplink and/or downlink data packets are transmitted in subframes. One subframe is defined as a predetermined time period including a plurality of OFDM symbols. The 3GPP LTE standard supports a type-1 radio frame structure applicable to frequency division duplex (FDD) and a type-2 radio frame structure applicable to time division duplex (TDD).

FIG. 1 illustrates the type-1 radio frame structure. A downlink radio frame is divided into 10 subframes. Each subframe is further divided into two slots in the time domain. A unit time during which one subframe is transmitted is defined as a Transmission Time Interval (TTI). For example, one subframe may be 1 ms in duration and one slot may be 0.5 ms in duration. A slot includes a plurality of OFDM symbols in the time domain and a plurality of resource blocks (RBs) in the frequency domain. Because the 3GPP LTE system adopts OFDMA for downlink, an OFDM symbol represents one symbol period. An OFDM symbol may be referred to as an SC-FDMA symbol or symbol period. An RB is a resource allocation unit including a plurality of contiguous subcarriers in a slot.

The number of OFDM symbols in one slot may vary depending on a cyclic prefix (CP) configuration. There are two types of CPs: extended CP and normal CP. In the case of the normal CP, one slot includes 7 OFDM symbols. In the case of the extended CP, the length of one OFDM symbol is increased and thus the number of OFDM symbols in a slot is smaller than in the case of the normal CP. Thus when the extended CP is used, for example, 6 OFDM symbols may be included in one slot. If channel state gets poor, for example, during fast movement of a UE, the extended CP may be used to further decrease inter-symbol interference (ISI).

In the case of the normal CP, one subframe includes 14 OFDM symbols because one slot includes 7 OFDM symbols. The first two or three OFDM symbols of each subframe may be allocated to a physical downlink control channel (PDCCH) and the other OFDM symbols may be allocated to a physical downlink shared channel (PDSCH).

The above-described radio frame structures are purely exemplary and thus it is to be noted that the number of subframes in a radio frame, the number of slots in a subframe, or the number of symbols in a slot may vary.

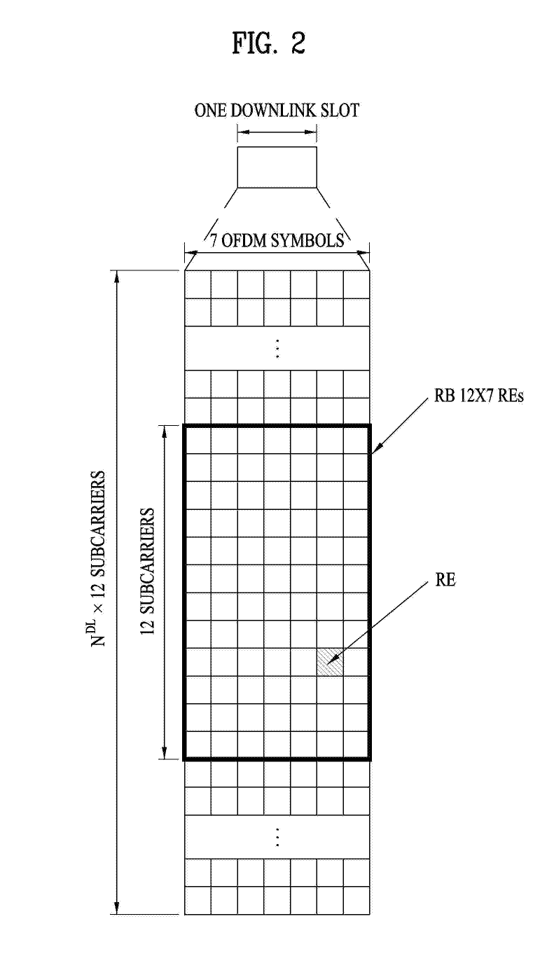

FIG. 2 illustrates the structure of a downlink resource grid for the duration of one downlink slot. FIG. 2 corresponds to a case in which an OFDM includes normal CP. Referring to FIG. 2, a downlink slot includes a plurality of OFDM symbols in the time domain and includes a plurality of RBs in the frequency domain. Here, one downlink slot includes 7 OFDM symbols in the time domain and an RB includes 12 subcarriers in the frequency domain, which does not limit the scope and spirit of the present invention. An element on a resource grid is referred to as a resource element (RE). For example, RE a(k,l) refers to RE location in a kth subcarrier and a first OFDM symbol. In the case of the normal CP, one RB includes 12×7 REs (in the case of the extended CP, one RB includes 12×6 REs). An interval between subcarriers is 15 kHz and thus one RB includes about 180 kHz in the frequency domain. NDL is number of RBs in a downlink slot. NDL depends on a downlink transmission bandwidth configured by BS scheduling.

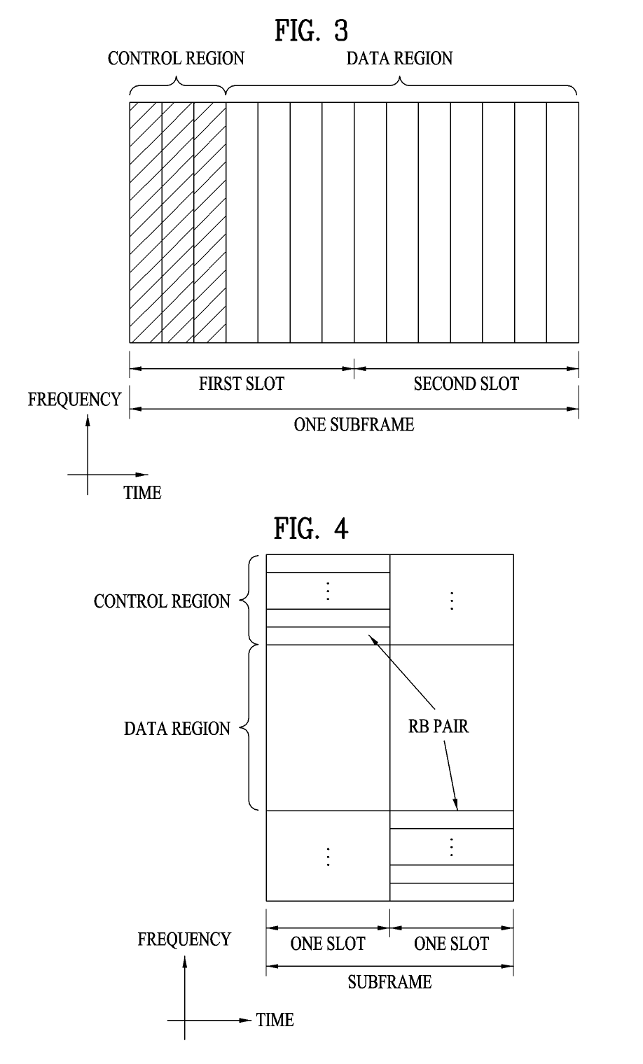

FIG. 3 illustrates the structure of a downlink subframe. Up to three OFDM symbols at the start of the first slot in a downlink subframe are used for a control region to which control channels are allocated and the other OFDM symbols of the downlink subframe are used for a data region to which a PDSCH is allocated. A basic unit of transmission is one subframe. That is, a PDCCH and a PDSCH are allocated across two slots. Downlink control channels used in the 3GPP LTE system include, for example, a physical control format indicator channel (PCFICH), a physical downlink control channel (PDCCH), and a physical hybrid automatic repeat request (HARQ) indicator channel (PHICH). The PCFICH is located in the first OFDM symbol of a subframe, carrying information about the number of OFDM symbols used for transmission of control channels in the subframe. The PHICH delivers an HARQ ACKnowledgment/Negative ACKnowledgment (ACK/NACK) signal in response to an uplink transmission. Control information carried on the PDCCH is called downlink control information (DCI). The DCI transports uplink or downlink scheduling information, or uplink transmission power control commands for UE groups. The PDCCH delivers information about resource allocation and a transport format for a downlink shared channel (DL-SCH), resource allocation information about an uplink shared channel (UL-SCH), paging information of a paging channel (PCH), system information on the DL-SCH, information about resource allocation for a higher-layer control message such as a random access response transmitted on the PDSCH, a set of transmission power control commands for individual UEs of a UE group, transmission power control information, voice over Internet protocol (VoIP) activation information, etc. A plurality of PDCCHs may be transmitted in the control region. A UE may monitor a plurality of PDCCHs. A PDCCH is formed by aggregating one or more consecutive Control Channel Elements (CCEs). A CCE is a logical allocation unit used to provide a PDCCH at a coding rate based on the state of a radio channel. A CCE corresponds to a plurality of RE groups. The format of a PDCCH and the number of available bits for the PDCCH are determined according to the correlation between the number of CCEs and a coding rate provided by the CCEs. An eNB determines the PDCCH format according to DCI transmitted to a UE and adds a cyclic redundancy check (CRC) to control information. The CRC is masked by an identifier (ID) known as a radio network temporary identifier (RNTI) according to the owner or usage of the PDCCH. When the PDCCH is directed to a specific UE, its CRC may be masked by a cell-RNTI (C-RNTI) of the UE. When the PDCCH is for a paging message, the CRC of the PDCCH may be masked by a paging indicator identifier (P-RNTI). When the PDCCH carries system information, particularly, a system information block (SIB), its CRC may be masked by a system information ID and a system information RNTI (SI-RNTI). To indicate that the PDCCH carries a random access response in response to a random access preamble transmitted by a UE, its CRC may be masked by a random access-RNTI (RA-RNTI).

FIG. 4 illustrates the structure of an uplink subframe. An uplink subframe may be divided into a control region and a data region in the frequency domain. A Physical Uplink Control Channel (PUCCH) carrying uplink control information is allocated to the control region and a physical uplink shared channel (PUSCH) carrying user data is allocated to the data region. To maintain the property of a single carrier, a UE does not transmit a PUSCH and a PUCCH simultaneously. A PUCCH for a UE is allocated to an RB pair in a subframe. The RBs of the RB pair occupy different subcarriers in two slots. Thus it is said that the RB pair allocated to the PUCCH is frequency-hopped over a slot boundary.

Modeling of MIMO System

A multiple input multiple output (MIMO) system increases transmission/reception efficiency of data using multiple transmission (Tx) antennas and multiple reception (Rx) antennas. MIMO technology does not depend upon a single antenna path in order to receive all messages but instead can combine a plurality of data fragments received through a plurality of antennas and receive all data.

MIMO technology includes a spatial diversity scheme, a spatial multiplexing scheme, etc. The spatial diversity scheme can increase transmission reliability or can widen a cell diameter with diversity gain and thus is appropriate for data transmission of a UE that moves a high speed. The spatial multiplexing scheme can simultaneously transmit different data so as to increase data transmission rate without increase in a system bandwidth.

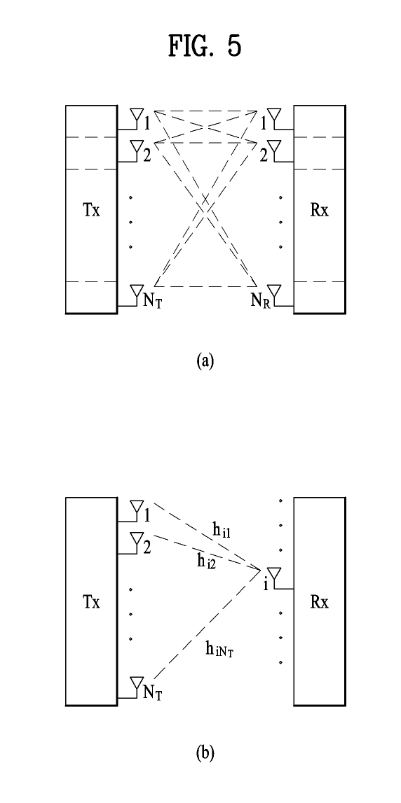

FIG. 5 illustrates the configuration of a MIMO communication system having multiple antennas. As illustrated in FIG. 5(a), the simultaneous use of a plurality of antennas at both the transmitter and the receiver increases a theoretical channel transmission capacity, compared to use of a plurality of antennas at only one of the transmitter and the receiver. Therefore, transmission rate may be increased and frequency efficiency may be remarkably increased. As channel transmission rate is increased, transmission rate may be increased, in theory, to the product of a maximum transmission rate Ro that may be achieved with a single antenna and a transmission rate increase Ri.

Rᵢ=(N_{T}, N_{R}) [Equation 1]

For instance, a MIMO communication system with four Tx antennas and four Rx antennas may achieve a four-fold increase in transmission rate theoretically, relative to a single-antenna system. Since the theoretical capacity increase of the MIMO system was verified in the middle 1990s, many techniques have been actively proposed to increase data rate in real implementation. Some of the techniques have already been reflected in various wireless communication standards for 3G mobile communications, future-generation wireless local area network (WLAN), etc.

Concerning the research trend of MIMO up to now, active studies are underway in many respects of MIMO, inclusive of studies of information theory related to calculation of multi-antenna communication capacity in diverse channel environments and multiple access environments, studies of measuring MIMO radio channels and MIMO modeling, studies of time-space signal processing techniques to increase transmission reliability and transmission rate, etc.

Communication in a MIMO system will be described in detail through mathematical modeling. It is assumed that NT Tx antennas and NR Rx antennas are present in the system.

Regarding a transmission signal, up to NT pieces of information can be transmitted through the NT Tx antennas, as expressed in Equation 2 below.

s=└s₁, s₂, . . . , s_{N}_{_{T}}┘^{T} [Equation 2]

A different transmission power may be applied to each piece of transmission information, s₁, s₂, . . . , S_{N}_{_{T}}. Let the transmission power levels of the transmission information be denoted by P₁, P₂, . . . , P_{N}_{_{T}}, respectively. Then the transmission power-controlled transmission information vector is given as

ŝ=[ŝ₁, ŝ₂, . . . , ŝ_{N}_{_{T}}]^{T}=[P₁s₁, P₂s₂, . . . , P_{N}_{_{T}}s_{N}_{_{T}}]^{T} [Equation 3]

The transmission power-controlled transmission information vector ŝ may be expressed as follows, using a diagonal matrix P of transmission power.

$$\hat{s} = [ \begin{matrix}{P}_{1} & & & 0 \\ & {P}_{2} & & \\ & & ⋱ & \\ 0 & & & {P}_{{N}_{T}}\end{matrix} ] [ \begin{matrix}{s}_{1} \\ {s}_{2} \\ ⋮ \\ {s}_{{N}_{T}}\end{matrix} ] = Ps \qquad [ Equation 4 ]$$

NT transmission signals x₁, x₂, . . . , x_{N}_{_{T}} may be generated by multiplying the transmission power-controlled information vectors ŝ by a weight matrix W. The weight matrix W functions to appropriately distribute the transmission information to the Tx antennas according to transmission channel states, etc. These NT transmission signals x₁, x₂, . . . , x_{N}_{_{T}} are represented as a vector x, which may be determined by Equation 5 below.

$$x = [ \begin{matrix}{x}_{1} \\ {x}_{2} \\ ⋮ \\ {x}_{i} \\ ⋮ \\ {x}_{{N}_{T}}\end{matrix} ] = [ \begin{matrix}{w}_{11} & {w}_{12} & … & {w}_{1 {N}_{T}} \\ {w}_{21} & {w}_{22} & … & {w}_{2 {N}_{T}} \\ ⋮ & & ⋱ & \\ {w}_{i 1} & {w}_{i 2} & … & {w}_{{iN}_{T}} \\ ⋮ & & ⋱ & \\ {w}_{{N}_{T} 1} & {w}_{{N}_{T} 2} & … & {w}_{{N}_{T} {N}_{T}}\end{matrix} ] [ \begin{matrix}{\hat{s}}_{1} \\ {\hat{s}}_{2} \\ ⋮ \\ {\hat{s}}_{j} \\ ⋮ \\ {\hat{s}}_{{N}_{T}}\end{matrix} ] = W \hat{s} = WPs \qquad [ Equation 5 ]$$

Here, wᵢⱼ refers to a weight between an ith Tx antenna and jth information.

A reception signal x may be considered in different ways according to two cases (e.g., spatial diversity and spatial multiplexing). In the case of spatial multiplexing, different signals are multiplexed and the multiplexed signals are transmitted to a receiver, and thus, elements of information vector (s) have different values. In the case of spatial diversity, the same signal is repeatedly transmitted through a plurality of channel paths and thus elements of information vectors (s) have the same value. A hybrid scheme of spatial multiplexing and spatial diversity can also be considered. That is, that same signal may be transmitted through three Tx antennas and the remaining signals may be spatial-multiplexed and transmitted to a receiver.

In the case of NR Rx antennas, a receiption signal of each antenna may be expressed as the vector shown in Equation 6 below.

y=[y₁, y₂, . . . , y_{N}_{_{T}}]^{T} [Equation 6]

When a channel modeling is executed in the MIMO communication system, individual channels can be distinguished from each other according to transmission/reception (Tx/Rx) antenna indexes. A channel passing the range from a Tx antenna j to an Rx antenna i is denoted by hij. It should be noted that the index order of the channel hij is located before a reception (Rx) antenna index and is located after a transmission (Tx) antenna index.

FIG. 5(b) illustrates channels from NT Tx antennas to an Rx antenna i. The channels may be collectively represented in the form of vector and matrix. Referring to FIG. 5(b), the channels passing the range from the NT Tx antennas to the Rx antenna i can be represented by the Equation 7 below.

hᵢ^{T}=[hᵢ₁, hᵢ₂, . . . , h_{iN}_{_{T}}] [Equation 7]

All channels passing the range from the NT Tx antennas to NR Rx antennas are denoted by the matrix shown in Equation 8 below.

$$H = [ \begin{matrix}{h}_{1}^{T} \\ {h}_{2}^{T} \\ ⋮ \\ {h}_{i}^{T} \\ ⋮ \\ {h}_{{N}_{R}}^{T}\end{matrix} ] = [ \begin{matrix}{h}_{11} & {h}_{12} & … & {h}_{1 {N}_{T}} \\ {h}_{21} & {h}_{22} & … & {h}_{2 {N}_{T}} \\ ⋮ & & ⋱ & \\ {h}_{i 1} & {h}_{i 2} & … & {h}_{{iN}_{T}} \\ ⋮ & & ⋱ & \\ {h}_{{N}_{R} 1} & {h}_{{N}_{R} 2} & … & {h}_{{N}_{R} {N}_{T}}\end{matrix} ] \qquad [ Equation 8 ]$$

Additive white Gaussian noise (AWGN) is added to an actual channel which has passed the channel matrix. The AWGN (n1, n2, . . . , nNR) added to each of NR reception (Rx) antennas can be represented by Equation 9 below.

n=[n₁, n₂, . . . , n_{N}_{_{R}}]^{T} [Equation 9]

A reception signal calculated by the above-mentioned equations can be represented by Equation 10 below.

$$y = [ \begin{matrix}{y}_{1} \\ {y}_{2} \\ ⋮ \\ {y}_{i} \\ ⋮ \\ {y}_{{N}_{R}}\end{matrix} ] = [ \begin{matrix}{h}_{11} & {h}_{12} & … & {h}_{1 {N}_{T}} \\ {h}_{21} & {h}_{22} & … & {h}_{2 {N}_{T}} \\ ⋮ & & ⋱ & \\ {h}_{i 1} & {h}_{i 2} & … & {h}_{{iN}_{T}} \\ ⋮ & & ⋱ & \\ {h}_{{N}_{g} 1} & {h}_{{N}_{g} 2} & … & {h}_{{N}_{N} {N}_{T}}\end{matrix} ] [ \begin{matrix}{x}_{1} \\ {x}_{2} \\ ⋮ \\ {x}_{j} \\ ⋮ \\ {x}_{{N}_{T}}\end{matrix} ] + [ \begin{matrix}{n}_{1} \\ {n}_{2} \\ ⋮ \\ {n}_{i} \\ ⋮ \\ {n}_{{N}_{R}}\end{matrix} ] = Hx + n \qquad [ Equation 10 ]$$

The number of rows and the number of columns of a channel matrix H indicating a channel condition are determined by the number of Tx/Rx antennas. In the channel matrix H, the number of rows is equal to the number (NR) of Rx antennas, and the number of columns is equal to the number (NT) of Tx antennas. Namely, the channel matrix H is denoted by an NR×NT matrix.

The rank of a matrix is defined as the smaller between the number of independent rows and the number of independent columns in the channel matrix. Accordingly, the rank of the channel matrix is not larger than the number of rows or columns of the channel matrix. The rank of a channel matrix H, rank(H) satisfies the following constraint.

rank(H)≦min(N_{T}, N_{R}) [Equation 11]

For MIMO transmission, ‘rank’ indicates the number of paths for independent transmission of signals and ‘number of layers’ indicates the number of streams transmitted through each path. In general, a transmission end transmits layers, the number of which corresponds to the number of ranks used for signal transmission, and thus, rank have the same meaning as number of layers unless there is no different disclosure.

Reference Signals (RSs)

In a wireless communication system, a packet is transmitted on a radio channel. In view of the nature of the radio channel, the packet may be distorted during the transmission. To receive the signal successfully, a receiver should compensate for the distortion of the reception signal using channel information. Generally, to enable the receiver to acquire the channel information, a transmitter transmits a signal known to both the transmitter and the receiver and the receiver acquires knowledge of channel information based on the distortion of the signal received on the radio channel. This signal is called a pilot signal or an RS.

In the case of data transmission and reception through multiple antennas, knowledge of channel states between transmission (Tx) antennas and reception (Rx) antennas is required for successful signal reception. Accordingly, an RS should be transmitted through each Tx antenna.

RSs in a mobile communication system may be divided into two types according to their purposes: RS for channel information acquisition and RS for data demodulation. Since its purpose lies in that a UE acquires downlink channel information, the former should be transmitted in a broad band and received and measured even by a UE that does not receive downlink data in a specific subframe. This RS is also used in a situation like handover. The latter is an RS that an eNB transmits along with downlink data in specific resources. A UE can estimate a channel by receiving the RS and accordingly can demodulate data. The RS should be transmitted in a data transmission area.

A legacy 3GPP LTE (e.g., 3GPP LTE release-8) system defines two types of downlink RSs for unicast services: a common RS (CRS) and a dedicated RS (DRS). The CRS is used for acquisition of information about a channel state, measurement of handover, etc. and may be referred to as a cell-specific RS. The DRS is used for data demodulation and may be referred to as a UE-specific RS. In a legacy 3GPP LTE system, the DRS is used for data demodulation only and the CRS can be used for both purposes of channel information acquisition and data demodulation.

CRSs, which are cell-specific, are transmitted across a wideband in every subframe. According to the number of Tx antennas at an eNB, the eNB may transmit CRSs for up to four antenna ports. For instance, an eNB with two Tx antennas transmits CRSs for antenna port 0 and antenna port 1. If the eNB has four Tx antennas, it transmits CRSs for respective four Tx antenna ports, antenna port 0 to antenna port 3.

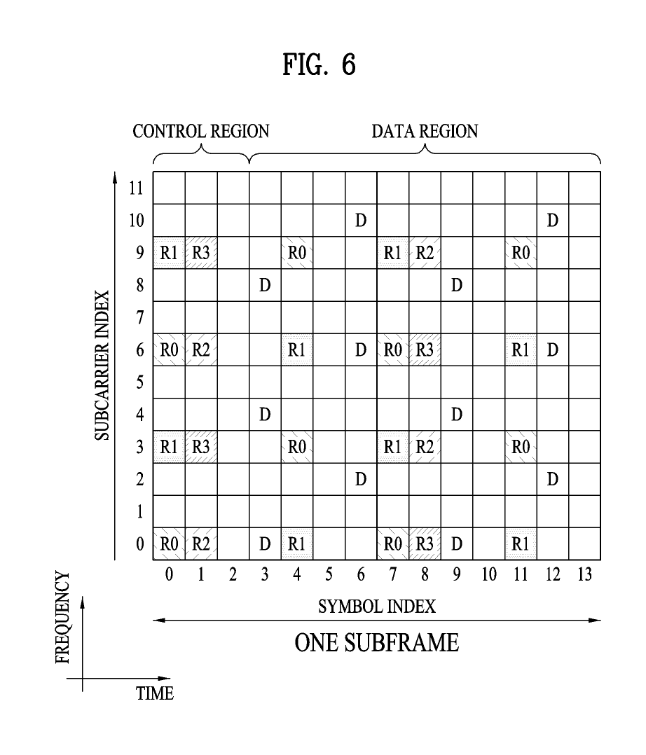

FIG. 6 illustrates a CRS and DRS pattern for an RB (including 14 OFDM symbols in time by 12 subcarriers in frequency in case of a normal CP) in a system where an eNB has four Tx antennas. In FIG. 6, REs labeled with ‘R0’, ‘R1’, ‘R2’ and ‘R3’ represent the positions of CRSs for antenna port 0 to antenna port 4, respectively. REs labeled with ‘D’ represent the positions of DRSs defined in the LTE system.

The LTE-A system, an evolution of the LTE system, can support up to eight Tx antennas. Therefore, it should also support RSs for up to eight Tx antennas. Because downlink RSs are defined only for up to four Tx antennas in the LTE system, RSs should be additionally defined for five to eight Tx antenna ports, when an eNB has five to eight downlink Tx antennas in the LTE-A system. Both RSs for channel measurement and RSs for data demodulation should be considered for up to eight Tx antenna ports.

One of significant considerations for design of the LTE-A system is backward compatibility. Backward compatibility is a feature that guarantees a legacy LTE terminal to operate normally even in the LTE-A system. If RSs for up to eight Tx antenna ports are added to a time-frequency area in which CRSs defined by the LTE standard are transmitted across a total frequency band in every subframe, RS overhead becomes huge. Therefore, new RSs should be designed for up to eight antenna ports in such a manner that RS overhead is reduced.

Largely, new two types of RSs are introduced to the LTE-A system. One type is CSI-RS serving the purpose of channel measurement for selection of a transmission rank, a modulation and coding scheme (MCS), a precoding matrix index (PMI), etc. The other type is demodulation RS (DM RS) for demodulation of data transmitted through up to eight Tx antennas.

Compared to the CRS used for both purposes of measurement such as channel measurement and measurement for handover and data demodulation in the legacy LTE system, the CSI-RS is designed mainly for channel estimation, although it may also be used for measurement for handover. Since CSI-RSs are transmitted only for the purpose of acquisition of channel information, they may not be transmitted in every subframe, unlike CRSs in the legacy LTE system. Accordingly, CSI-RSs may be configured so as to be transmitted intermittently (e.g. periodically) along the time axis, for reduction of CSI-RS overhead.

When data is transmitted in a downlink subframe, DM RSs are also transmitted dedicatedly to a UE for which the data transmission is scheduled. Thus, DM RSs dedicated to a particular UE may be designed such that they are transmitted only in a resource area scheduled for the particular UE, that is, only in a time-frequency area carrying data for the particular UE.

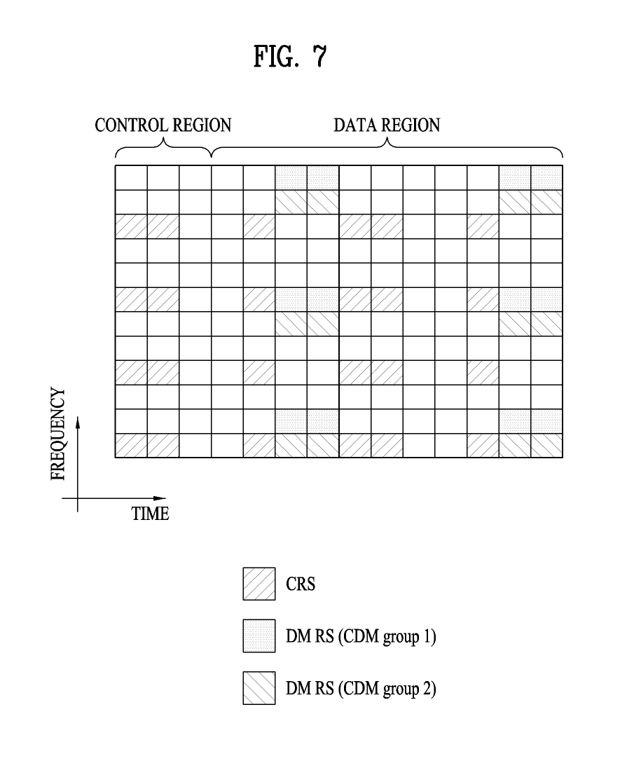

FIG. 7 illustrates an exemplary DM RS pattern defined for the LTE-A system. In FIG. 7, the positions of REs carrying DM RSs in an RB carrying downlink data (an RB having 14 OFDM symbols in time by 12 subcarriers in frequency in case of a normal CP) are marked. DM RSs may be transmitted for additionally defined four antenna ports, antenna port 7 to antenna port 10 in the LTE-A system. DM RSs for different antenna ports may be identified by their different frequency resources (subcarriers) and/or different time resources (OFDM symbols). This means that the DM RSs may be multiplexed in frequency division multiplexing (FDM) and/or time division multiplexing (TDM). If DM RSs for different antenna ports are positioned in the same time-frequency resources, they may be identified by their different orthogonal codes. That is, these DM RSs may be multiplexed in Code Division Multiplexing (CDM). In the illustrated case of FIG. 7, DM RSs for antenna port 7 and antenna port 8 may be located on REs of DM RS CDM group 1 through multiplexing based on orthogonal codes. Similarly, DM RSs for antenna port 9 and antenna port 10 may be located on REs of DM RS CDM group 2 through multiplexing based on orthogonal codes.

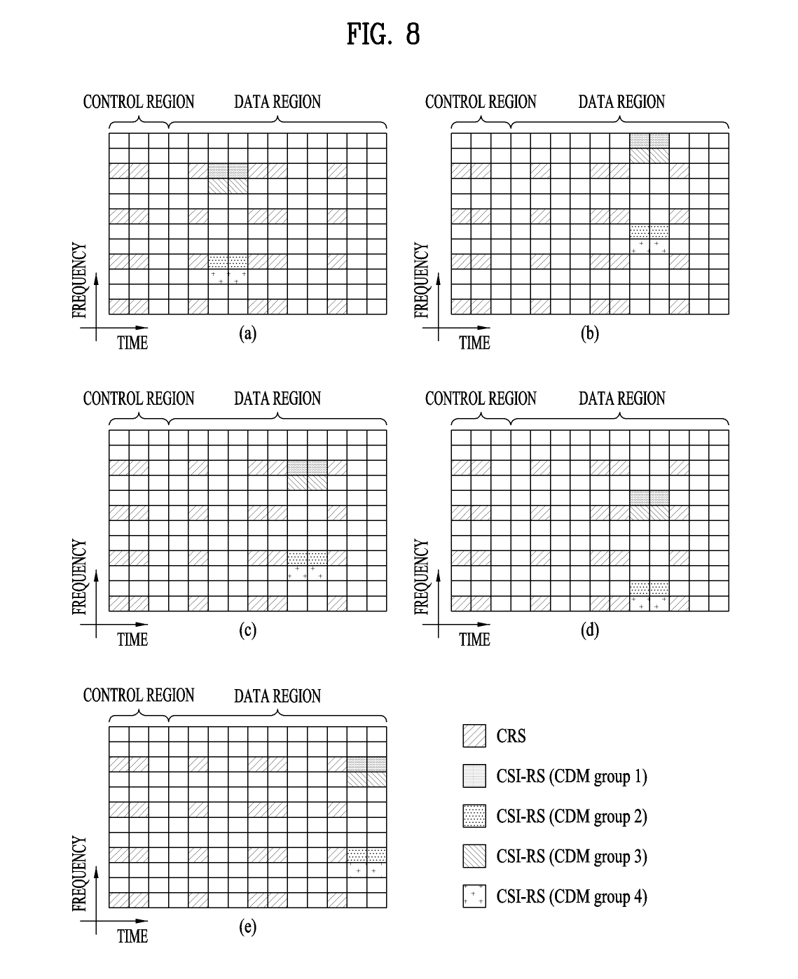

FIG. 8 illustrates exemplary CSI-RS patterns defined for the LTE-A system. In FIG. 8, the positions of REs carrying CSI-RSs in an RB carrying downlink data (an RB having 14 OFDM symbols in time by 12 subcarriers in frequency in case of a normal CP) are marked. One of the CSI-RS patterns illustrated in FIGS. 8(a) to 8(e) is available for any downlink subframe. CSI-RSs may be transmitted for eight antenna ports supported by the LTE-A system, antenna port 15 to antenna port 22. CSI-RSs for different antenna ports may be identified by their different frequency resources (subcarriers) and/or different time resources (OFDM symbols). This means that the CSI-RSs may be multiplexed in FDM and/or TDM. CSI-RSs positioned in the same time-frequency resources for different antenna ports may be identified by their different orthogonal codes. That is, these DM RSs may be multiplexed in CDM. In the illustrated case of FIG. 8(a), CSI-RSs for antenna port 15 and antenna port 16 may be located on REs of CSI-RS CDM group 1 through multiplexing based on orthogonal codes. CSI-RSs for antenna port 17 and antenna port 18 may be located on REs of CSI-RS CDM group 2 through multiplexing based on orthogonal codes. CSI-RSs for antenna port 19 and antenna port 20 may be located on REs of CSI-RS CDM group 3 through multiplexing based on orthogonal codes. CSI-RSs for antenna port 21 and antenna port 22 may be located on REs of CSI-RS CDM group 4 through multiplexing based on orthogonal codes. The same principle described with reference to FIG. 8(a) is applicable to the CSI-RS patterns illustrated in FIGS. 8(b) to 8(e).

FIG. 9 illustrates an example of a ZP (zero power) CSI-RS pattern defined in the LTE-A system. There are two main purpose of ZP CSI-RS. First of all, the ZP CSI-RS is used for CSI-RS performance improvement. In particular, in order to improve performance of measurement for C SI-RS of a different network, a network may perform muting on CSI-RS RE of the different network and then inform a UE in the corresponding network of the muted RE by setting it to the ZP CSI-RS in order for the UE to perform rate matching correctly. Secondly, the ZP CSI-RS is used for the purpose of measuring interference for a CoMP CQI calculation. In particular, CoMP CQI can be calculated in a manner that a network performs muting on ZP CSI-RS RE and that a UE measures interference from ZP CSI-RS.

The RS patterns illustrated in FIGS. 6 to 9 are just exemplary. Thus, it should be understood that various embodiments of the present invention are not limited to a specific RS pattern. In particular, it is apparent that the various embodiments of the present invention can be implemented in the same manner even if RS patterns different than those illustrated in FIGS. 6 to 9 are applied.

Cooperative Multipoint Transmission/Reception (CoMP) System

Hereinafter, CoMP (cooperative multipoint transmission/reception) is described.

A system appearing after LTE-A has attempted to introduce a scheme of enhancing system performance by enabling a plurality of cells to cooperate with each other. Such a scheme is called a cooperative multipoint transmission/reception (hereinafter abbreviated CoMP). The CoMP refers to a scheme for two or more base stations, access points, or cells to cooperatively communicate with a specific user equipment for smooth communication between the user equipment and the base stations, the access points, or the cells. In the present invention, a base station, an access point, and a cell may have the same meaning.

In general, in a multi-cell environment having a frequency reuse factor set to 1, performance and average sector throughput of a user equipment located at a cell boundary may be lowered due to inter-cell interference (ICI). In order to reduce the ICI, a conventional LTE system has applied a method of providing an appropriate throughput performance to a user equipment located at a cell boundary in an environment restricted by interference using a simple manual scheme such as FFR (fractional frequency reuse) through UE-specific power control. However, reduction of the ICI or reuse of the ICI as a signal desired by a user equipment may be more preferable than lowering a frequency resource use per cell. In order to achieve the aforementioned purpose, the CoMP transmission scheme can be applied.

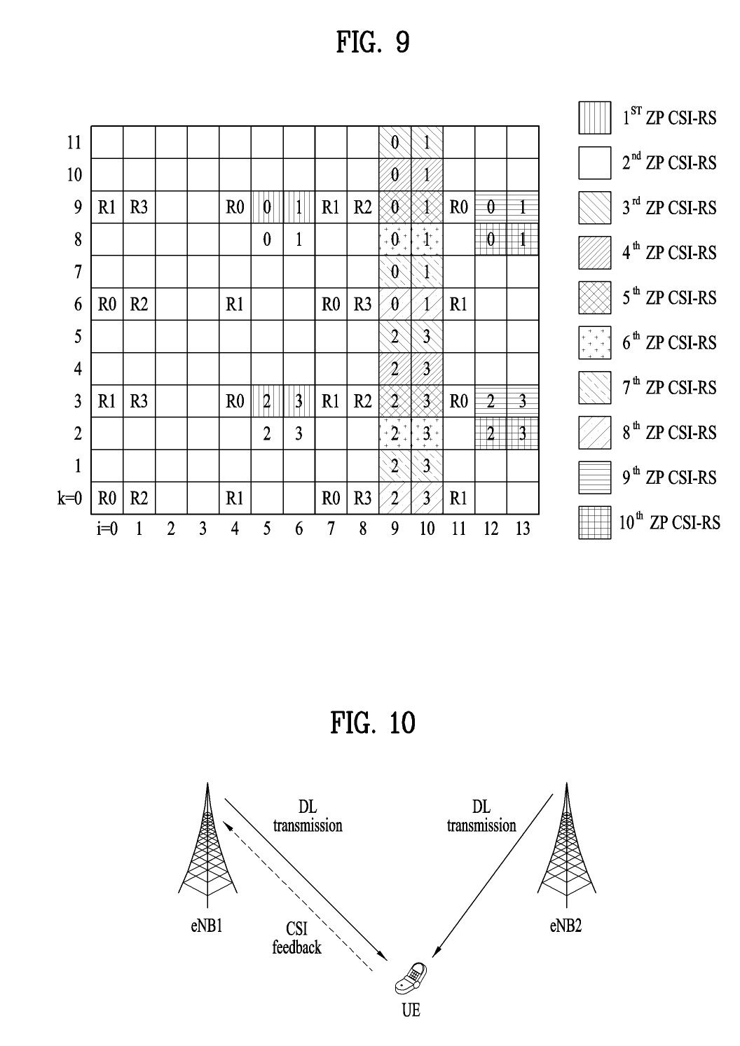

FIG. 10 is a diagram for one example of performing CoMP. Referring to FIG. 10, a wireless communication system includes a plurality of base stations (BS1, BS2 and BS3) performing CoMP and a user equipment. A plurality of the base stations (BS1, BS2 and BS3) performing the CoMP may efficiently transmit data to the user equipment by cooperating with each other.

The CoMP transmission scheme may be categorized into a join processing (CoMP-joint processing, CoMP-JP) scheme in the form of cooperative MIMO through data sharing and a coordinated scheduling/beamforming (CoMP-coordinated scheduling/beamforming, CoMP-CS/CB) scheme.

According to the joint processing (CoMP-JP) scheme in downlink, a user equipment may simultaneously receive data from a plurality of base stations performing the CoMP transmission scheme. And, a reception performance can be enhanced in a manner of combining signals received from the base stations (joint transmission (JT)). And, it is also possible to consider a method of transmitting data to a user equipment on a specific timing by one of the base stations performing the CoMP transmission scheme (dynamic point selection (DPS)). On the other hand, according to the coordinated scheduling/beamforming method (CoMP-CS/CB), a user equipment may instantaneously receive data from a single base station i.e., a serving base station through a beamforming.

According to the joint processing (CoMP-JP) scheme in uplink, a plurality of base stations may simultaneously receive PUSCH signal from a user equipment (joint reception (JR)). On the other hand, according to the coordinated scheduling/beamforming method (CoMP-CS/CB), only a single base station may receive the PUSCH. In this case, the decision to use the coordinated scheduling/beamforming scheme is determined by the coordinating cells (or base stations).

CSI Feedback in CoMP System

A user equipment using the CoMP transmission scheme, that is, a CoMP UE may provide feedback of channel information (hereinafter referred to as CSI feedback) to a plurality of base stations that perform the CoMP transmission scheme. A network scheduler may select an appropriate CoMP transmission scheme for enhancing a transmission rate from CoMP-JP, CoMP-CS/CB, and DPS schemes based on CSI feedback. To this end, as a method for a CoMP UE to configure CSI feedback for a plurality of base stations that perform a CoMP transmission scheme, a periodic feedback transmission scheme using uplink PUCCH may be used. In this case, feedback configurations for the respective base stations may be independent from each other. Accordingly, according to an embodiment of the present invention, throughout this specification, a feedback operation of channel information using the independent feedback configuration is referred to as a CSI process. One or more CSI processes may exist in one serving cell.

FIG. 10 is a diagram for one example of performing CoMP.

Referring to FIG. 10, UE is located between eNB 1 and eNB 2 and two eNBs (i.e., eNB 1 and eNB 2) perform appropriate CoMP operations such as JT, DCS and CS/CB to solve a problem of interference caused to the corresponding UE. The UE performs appropriate CSI feedback to assist CoMP operations of the eNBs (base stations). Information transmitted through CSI feedback includes PMI information and CQI information of each eNB and may additionally include channel information (e.g., phase offset information between channels of the two eNBs) between the two eNBs for JT.

In FIG. 10, although the UE transmits a CSI feedback signal to the eNB 1 corresponding to its serving cell, the UE may transmit the CSI feedback signal to the eNB 2 or to both of the two eNBs depending on situations. Moreover, although in FIG. 10, eNB is described as a basic unit for joining CoMP, a transmission point controlled by eNB may become the basic unit for the CoMP as well.

For CoMP scheduling in a network, UE should provide feedback of downlink CSI of a neighbor eNB, which participates in the CoMP, as well as DL CSI of a serving eNB. To this end, the UE needs to provide feedback of a plurality of CSI processes, which reflect various eNBs for data transmission and various interference environments.

Thus, an interference measurement resource (IMR) is used for interference measurement during a CoMP CSI calculation in LTE system. A plurality of IMRs may be configured for one UE, and one UE has independent configuration for each of the IMRs. In particular, period, offset and resource configuration of each IMR are independently configured and a base station may signal to UE through high layer signaling such as RRC (radio resource control) signaling or the like.

Moreover, in the LTE system, CSI-RS is used for measurement for a desired channel during the CoMP CSI calculation. A plurality of CSI-RSs may be configured for one UE and each of the CSI-RSs has independent configuration. In particular, period, offset, resource configuration, power control (PC), and the number of antenna ports of each CSI-RS are independently configured. And, information related to CSI-RS may be signaled from a base station to UE through high layer signaling (e.g., RRC, etc.).

One CSI process is defined in a manner of associating one CSI-RS resource for signal measurement with one IMR (interference measurement resource) for interference measurement among a plurality of the CSI-RSs and IMRs, which are configured for the UE. Each CSI derived from different CSI processes is fed back by the UE based on an independent period and subframe offset.

In particular, each CSI process has independent CSI feedback configuration. Information on the association of the CSI-RS resource and the IMR resource, CSI feedback configuration and the like may be informed UE by a base station in each CSI process through high layer signaling such as RRC. For example, it is assumed that three CSI processes are configured for UE as shown in Table 1.

TABLE 1

| | Signal Measurement | |
|---|---|---|
| CSI Process | Resource (SMR) | IMR |
| CSI process 0 | CSI-RS 0 | IMR 0 |
| CSI process 1 | CSI-RS 1 | IMR 1 |
| CSI process 2 | CSI-RS 0 | IMR 2 |

In Table 1, CSI-RS 0 and CSI-RS 1 represent CSI-RS received from the eNB 1 corresponding to a serving base station (serving eNB) of the UE and CSI-RS received from the eNB 2 corresponding to a neighbor eNB participating in cooperation, respectively. It is assumed that IMR configured for each CSI process of Table 1 is configured as illustrated in Table 2.

TABLE 2

| IMR | eNB 1 | eNB 2 |
|---|---|---|
| IMR 0 | Muting | Data transmission |
| IMR 1 | Data transmission | Muting |
| IMR 2 | Muting | Muting |

On IMR 0, the eNB 1 performs muting, the eNB 2 performs data transmission, and the UE is configured to measure interference from different eNBs except the eNB 1. Likewise, on IMR 1, the eNB 2 performs muting, the eNB 1 performs data transmission, and the UE is configured to measure interference from different eNBs except the eNB 2. Also, on IMR 2, both of the eNB 1 and the eNB 2 perform muting and the UE is configured to measure interference from different eNBs except both of the eNB 1 and the eNB 2.

Therefore, as shown in Table 1 and Table 2, CSI of CSI process 0 represents optimized RI, PMI and CQI information in the case of receiving data from the eNB 1. CSI of CSI process 1 represents optimized RI, PMI and CQI information in the case of receiving data from the eNB 2. CSI of CSI process 2 represents optimized RI, PMI and CQI information in the case that data is received from the eNB 1 and that there is no interference from the eNB 2.

Method for Measuring Feedback in MBSFN

MBMS (multicast broadcast multimedia services) uses MBSFN (multicast-broadcast single frequency network) transmission, where signals received from a plurality of different base stations (BSs) are combined in a user equipment. Such a signal combination makes the MBSFN transmission different from unicast transmission. Thus, it is difficult to apply technologies for the unicast transmission to the MBSFN transmission. For instance, if there is no feedback such as HARQ to a radio access network (RAN), the RAN may not know whether signal transmission is successfully received. In other words, if there is no feedback of the MBSFN transmission, it is difficult to measure the transmission quality of the MBMS. In this case, although a manual drive test method can be used for optimizing and verifying the MBSFN transmission, the method requires high cost and causes the emission of carbon dioxide. Moreover, the method has a limitation depending on a location of an MBMS user. Therefore, a new method for feedback information of the MBSFN transmission is required.

MBSFN RSRP (reference signal received power) is measured with reference to MBSFN RS unlike legacy RSRP. The MBSFN RSRP can be defined as follows.

The MBSFN RSRP is defined as a linear average over power contributions [W] of resource elements that carry MBSFB RS within a considered measurement frequency bandwidth. To determine the MBSFN RSRP, the MBSFN RS may be used.

MBSFN RSRQ (reference signal received quality) is a ratio of MBSFN RSRP to MBSFN RSSI, and more particularly, is defined as (N×MBSFN RSRP)/(E-UTRA carrier MBSFN RSSI), where N is the number of RBs of E-UTRA carrier MBSFN RSSI measurement bandwidth. The reference point for the MBSFN RSRQ may be an antenna connector of a UE.

Moreover, MBSFN RSRP and MBSFN RSRQ are defined in each MBSFN area. In this case, the MBSFN RSRP and the MBSFN RSRQ are measured with reference to MBSFN RS used in a corresponding MBSFN area.

MBSFN RSSI (received signal strength indicator) is defined as follows. The E-UTRA carrier MBSFN RSSI represents a linear average of total received power (expressed in a unit of [W]), which is observed by a UE in specific OFDM symbols in a measurement bandwidth over the number N of RBs from all sources including a co-channel serving cell, a non-serving cell, adjacent cell interference, thermal noise, and the like.

### Embodiment 1

The embodiment 1 of the present invention relates to a method of determining a location of an OFDM symbol for MBSFN RSSI measurement. Specific OFDM symbols for MBSFN RSSI measurement can be determined according to the following embodiments 1-1 to 1-5.

### Embodiment 1-1

According to the embodiment 1-1, MBSFN RSSI may be determined as a linear average of total received power (expressed in a unit of [W]) observed only in OFDM symbols including MSBSFN RS.

The conventional RSSI is measured in the same symbol as that used for RSRP measurement. On the basis of this result, the MBSFN RSSI may be defined to be measured in the same symbol together with the MBSFN RSRP. In particular, only OFDM symbols including the MBSFN RS are used for MBSFN RSSI measurement.

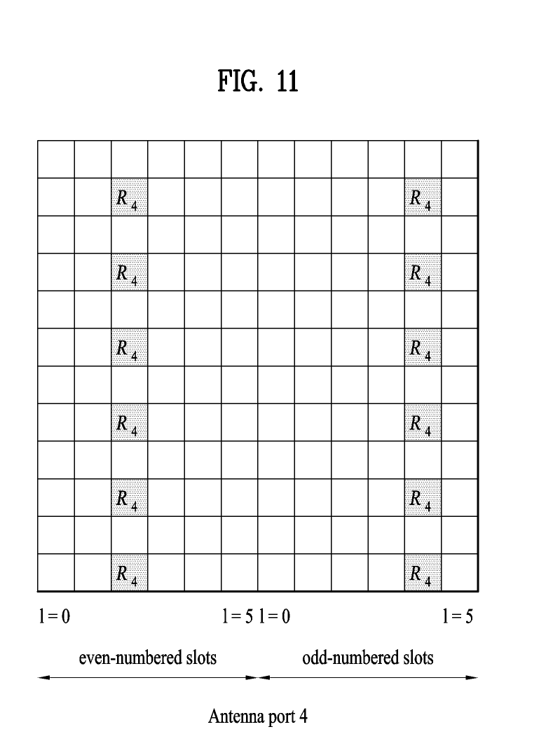

Among the above OFDM symbols, some OFDM symbols may reflect CRS interference which is caused to MBSFN data by an interfering cell. For instance, CRS interference of an adjacent cell that uses an extended CP exists at 0^{th} OFDM symbol in odd-numbered slots in FIG. 11. Consequently, part of the CRS interference is reflected in the MBSFN RSSI. However, since the MBSFN RSSI reflects the part of the CRS interference, it may generate MB SFN RSRQ having mitigated interference rather than actual interference.

### Embodiment 1-2

According to the embodiment 1-2, MBSFN RSSI may be determined as a linear average of total received power (expressed in a unit of [W]) observed in all OFDM symbols in an MBSFN area.

In particular, to generate MBSFN RSRQ reflecting CRS interference of an adjacent cell, OFDM symbols utilized for MBSFN RSSI measurement can be defined as all the OFDM symbols existing in the MBSFN area. Since all the OFDM symbols existing in the MBSFN area include all CRS interference from an interfering cell, which affect MBSFN data, MBSFN RSSI measurement according to the embodiment 1-2 may reflect interference accurately compared to the case of the embodiment 1-1.

Moreover, for instance, even if the adjacent cell does not transmit data, since CRS transmission is always performed, the CRS interference should be reflected in the MBSFN RSSI in order to generate accurate MBSFN RSRQ. According to the embodiment 1-1, since the CRS interference is reflected partially or not at all in the MBSFN RSSI, the MBSFN RSRQ is generated based on a value smaller than the amount of interference actually received by a UE. On the other hand, according to the embodiment 1-2, the MBSFN RSRQ in which entire CRS interference is reflected can be generated and reported accurately.

### Embodiment 1-3

According to the embodiment 1-3, MBSFN RSSI may be determined as a linear average of total received power (expressed in a unit of [W]) observed only in OFDM symbols of antenna port 0 of interfering cell CRS in an MBSFN area.

An adjacent cell performing non-MBSFN transmission always causes CRS interference to MBSFN data irrespective of whether the adjacent cell transmits data. Moreover, since coverage of CRS is greater than that of data, CRS interference is stronger than data interference in general. Therefore, for correct MBSFN RSRQ measurement, it is mandatory to reflect the CRS interference in the MBSFN RSSI accurately. To this end, a method of measuring MBSFN RSSI in symbols in which CRS of an adjacent cell exists is proposed in the embodiment 1-3.

According to the embodiment 1-3, since the MBSFN RSSI is measured based on only the symbols having CRS interference existing therein, compared to a case that the MBSFN RSSI is measured in all symbols existing in the MBSFN area, interference is reflected strongly. In this point, the MBSFN RSSI calculated according to the embodiment 1-3 may be referred to as a worst case.

A location of the CRS of the adjacent cell may differ depending on CP (cyclic prefix) of OFDM used in the adjacent cell. Thus, a UE receiving MBMS should be aware of OFDM CP information of the adjacent cell. Based on this information, the UE modifies OFDM symbols corresponding to MBSFN RSSI measurement targets.

For the CP information of the adjacent cell, coordination between the adjacent cell and an MBSFN network may be performed in advance. Alternatively, after receiving the CP information from the adjacent cell, the MBSFN network can inform an MBMS reception UE of the CP information through RRC signaling and the like. If a channel capable of transmitting and receiving control information is established between the interfering cell and the MBMS reception UE, the CP information can be directly transmitted through the channel.

If the CP used in the adjacent cell is extended CP, the RSSI is measured in symbols in which CRS port 0 of the adjacent cell is transmitted, i.e., symbol 3 of a first slot and symbols 0 and 3 of a second slot in an MBSFN subframe. For the convenience of the explanation, the above symbols used for RSSI measurement are called a symbol set A.

If the CP used in the adjacent cell is normal CP, an MBSFN OFDM symbol does not match an adjacent cell OFDM symbol on a time axis. In this case, the RSSI is measured in symbols overlapped partially or fully with the subframes in which the CRS port 0 of the adjacent cell is transmitted, i.e., symbols 3 and 4 of the first slot and symbols 0, 3, and 4 of the second slot in the MBSFN subframe. The above symbols used for the RSSI measurement are called a symbol set B.

For simple UE implementation, a UE may measure the RSSI using symbols in set A corresponding to an intersection of the symbol set A and the symbols set B. Alternatively, the UE may measure the RSSI using symbols in set B corresponding to an union of the symbol sets A and B.

If a subframe of the adjacent cell is synchronized with that of the MBSFN network, the set A and set B are valid. However, even if the subframes of the adjacent cell and the MBSFN network are not synchronized with each other, the sets A and B can be reconfigured in the same manner and then used.

In addition, the set A and set B are defined on the assumption of a case of subcarrier spacing, Δf=15 kHz in the MBSFN network. Even in case of f=7.5 kHz, the set A and set B can be reconfigured with reference to a symbol location of CRS corresponding to antenna port 0 of the adjacent cell, whereby the method according to the embodiment 1-3 can be used.

### Embodiment 1-4

According to the embodiment 1-4, MBSFN RSSI may be determined as a linear average of total received power (expressed in a unit of [W]) observed in MBSFN RS and OFDM symbols of antenna port 0 of interfering cell CRS in an MBSFN area.

In case of MBSFN RSRQ calculated according to the embodiment 1-1, MBSFN RSSI and MBSFN RSRP corresponding to a numerator and a denominator respectively are calculated based on the same symbol, whereby the MBSFN RSRQ can efficiently indicate a power ratio with respect to the same resource. On the other hand, in the embodiments 1-2 and 1-3, symbols used for MBSFN RSSI measurement may be different from those used for the MBSFN RSRP measurement and thus CRS interference can be efficiently reflected.

According to the embodiment 1-4, when symbols used for the MBSFN RSSI measurement are determined, symbols used for the MBSFN RSRP measurement are included together with symbols in which the CRS interference exists. Thus, the CRS interference is appropriately reflected in the RSRQ and the MBSFN RSSI and the MBSFN RSRP are also calculated based on the almost same symbols.

### Embodiment 1-5

According to the embodiment 1-5, MBSFN RSSI may be determined as a linear average of total received power (expressed in a unit of [W]) observed in OFDM symbols indicated to a user equipment by a base station. For instance, a network/base station informs a UE of OFDM symbols in which MBSFN RSSI is measured through RRC signaling or the like.

### Embodiment 2

The embodiment 2 relates to a method of configuring a frequency time resource region corresponding to a target for RSSI measurement.

To calculate MBSFN RSSI, a UE averages received signal power with respect to a specific frequency time resource. In this case, according to the embodiment 2, a time frequency resource region corresponding to a target to be averaged is designated by a base station for the UE. The UE calculates an average of REs satisfying the aforementioned MBSFN RSSI definition in the resource region.

Since the time frequency resource region corresponding to the target to be averaged is designated by the base station, interference power does not have a flat characteristic on a time or frequency axis. Thus, MBSFN RSRQ can be calculated more accurately in a fluctuating environment. In particular, the base station configures the time frequency resource region corresponding the averaging target to be larger in consideration of such interference fluctuation. Therefore, it prevents the UE from determining the MBSFN RSSI according to the amount of instantaneous interference occurring in a specific subframe/RB.

For instance, if a UE calculates RSSI based on only a single MBSFN subframe in an environment with strong interference fluctuation, the UE may calculate the MB SFN RSSI depending on the amount of instantaneous interference of the corresponding MBSFN subframe. However, if the amount of interference is significantly changed in a next MBSFN subframe, it is difficult to utilize RSRQ calculated with reference to the MBSFN RSSI as a metric for determining an MBSFN shadow area from a long-term point of view.

The time frequency resource region corresponding to the target to be averaged aims at the MBSFN subframe and it can be transmitted in the form of a bitmap or a window size. In the case of the bitmap form, there are bitmaps for MBSFN subframes existing during an MBSFN RSSI measurement period and MBSFN subframes that should be averaged are set to 1. The window size is transmitted as a value of n. If a UE receives this value, the UE calculates the MBSFN RSSI by averaging the number n of the MBSFN subframes existing during the MBSFN RSSI measurement period.

Alternatively, the base station may configure a minimized resource region to overcome the interference fluctuation instead of designating the resource region for the UE. And, the UE measures the MBSFN RSSI based on the minimized resource region or a region including the minimized resource region.

Although the method according to the aforementioned embodiment 2 is described with reference to the MBSFN RSSI, it can be applied for an MBSFN RSRP calculation. For instance, in case of determining MBSFN RSRQ, a UE determines the MBSFN RSSI and MBSFN RSRP by calculating an average with respect to the same determined frequency time resource region. In this case, the MBSFN RSRP is determined based on REs satisfying the aforementioned MBSFN RSRP definition.

Alternatively, a UE measures the MBSFN RSRP in a manner of autonomously determining a resource region corresponding to a measurement target similar to the conventional RSRP calculation scheme. And, the UE measures only the RSSI based on the same determined frequency time resource region.

### Embodiment 3

The embodiment 3 relates to a multiple RSRQ reporting scheme.

If an interfering cell uses only some bands of a frequency bandwidth in an MBSFN network, the interfering cell causes interference to the only some bands of a full MBSFN bandwidth. For instance, if the MBSFN network uses one bandwidth of 10-MHz for band A and the interfering cell uses one bandwidth of 5-MHz for the same band A, the interfering cell causes interference to only a band corresponding to 5-MHz in an MBSFN band. In this case, a UE calculates MBSFN RSSI for only the specific band in the full MBSFN band and then reports MBSFN RSRQ using the calculated MBSFN RSSI. On the basis of this result, the MBSFN RSSI is calculated for each of a plurality of specific bands in which presence or non-presence of interference from the interfering cell is changed and each MBSFN RSRQ is reported using the calculated MBSFN RSSI. For instance, 10-MHz of a full MBSFN band is divided into subband A and subband B corresponding to 5-MHz of an upper band and 5-MHz of a lower band, respectively. A UE calculates the MBSFN RSSI and the MBSFN RSRQ for each of the subbands A and B and then reports two MBSFN RSRQ to a base station.

Similarly, MBSFN RSRP can be also measured based on some bands and a UE can report MBSFN RSRP for each subband.

### Embodiment 4

The embodiment 4 relates to an MBSFN UE measurement resource determined according to a UE speed.

According to the above-mentioned embodiment 2, a time frequency resource region corresponding to a target to be averaged is designated by a base station. Consequently, interference power does not have a flat characteristic on a time or frequency axis and MBSFN RSRQ can be calculated more accurately in a fluctuating environment.

According to the embodiment 4, a UE may additionally configure a time frequency resource region corresponding a target to be averaged for MBSFN UE measurement. In particular, a UE that moves with high speed configures the time frequency resource region to be smaller and a UE that move with low speed configures the time frequency resource region to be larger.

The high-speed UE may escape from an MBSFN shadow area or enter the MBSFN shadow area quickly. In this case, if time resources corresponding to the target to be averaged for the MBSFN UE measurement are set to be long, a calculated metric may be inaccurate. In particular, the UE is highly likely to enter the MBSFN shadow area from outside or to escape from the MBSFN shadow area to outside during the long time corresponding to the target to be averaged. In this case, since signal strengths or SINR values inside and outside of the shadow area are averaged together and reflected in the calculated metric, the base station is unable to determine the shadow area based on the above-mentioned metric.

On the other hand, the low-speed UE may stay in or out of the MBSFN shadow area for a long time. In this case, although the time resources corresponding to the target to be averaged for the MBSFN UE measurement are set to be long, the calculated metric is highly likely to be accurate. Moreover, since the metric is calculated by averaging time resources set to be long, the number of average samples is large as well. Accordingly, the UE can calculate the metric with high accuracy.

### Embodiment 5

The embodiment 5 relates to MBSFN CQI.

For the conventional CQI calculation, a UE measures a channel with reference to CRS or CSI-RS and then calculates a highest MCS satisfying FER 0.1 from CSI reference resources. On the other hand, for an MBSFN CQI calculation, a UE measures a channel with reference to MBSFN RS and then calculates a highest MCS satisfying BLER 0.1 from CSI reference resource.

According to the embodiment 5, when calculating MBSFN CQI, a UE may calculate MCS in terms of variable BLER instead of fixed BLER as mentioned in the foregoing description.

For instance, a base station indicates target BLER to a UE through RRC and the UE reports CQI by calculating MCS that satisfies the target BLER.

If the base station indicates the target BLER as mentioned in the foregoing description, a network may manage different QoS (quality of service) depending on types of MBMS.

In addition, according to the above scheme, the base station may know which BLER is induced by MCS of currently transmitted MBMS data in each UE. For instance, assuming that of two UEs receiving MBMS, UE 1 is located in an MBSFN shadow area and UE 2 is located in an area with high MBSFN reception rate, BLER 0.2 and BLER 0.001 are configured for the UE 1 and the UE 2, respectively. In case that MCS of the current MBSFN data is assumed to be 10, if each of the UE 1 and the UE 2 report MCS 10, the base station is able to know that BLER of the UE 1 and BLER of the UE 2 correspond to 0.2 and 0.001, respectively.

### Embodiment 6

The embodiment 6 relates to a method of RRC-indicating an MBSFN UE measurement resource based on an FEC protection period.

A UE performs correction of a packet error in an application layer (AL) of OSI 7 layer through FEC (forward error correction). To this end, a base station generates a single FEC source block in the application layer with reference to RTP packets created during a protection period and then generates repair symbols by applying a raptor code to the generated source block. The generated source symbols and repair symbols are transmitted through tens or hundreds of subframes in a physical layer.

The base station uses MBSFN UE measurement to determine a code rate of the AL FEC. In this case, the base station needs to designate time frequency resources corresponding to a target to be averaged for the MBSFN UE measurement in order to set a correct code rate. In particular, if the MBSFN UE measurement is calculated based on a small number of subframes among subframes in which one FEC source block and the corresponding repair symbols are transmitted, the calculated value is not correct enough to determine the code rate of the AL FEC. For instance, in case that one FEC source block and repair symbols are transmitted through total 100 ms, if a UE calculates MBSFN UE measurement based on only one subframe, channel diversity is not sufficiently reflected in a metric.

Thus, the base station should estimate transmission duration by checking a subframe used for initial transmission of one FEC source block and the corresponding repair symbols and a subframe used for last transmission of one FEC source block and the corresponding repair symbols and then determine the time frequency resource region corresponding to the target to be averaged for the MBSFN UE measurement based on the estimated value. The determined time frequency resource region is RRC-indicated to the UE by the base station.

### Embodiment 7

The embodiment 7 relates to MBSFN CQI. For the convenience of the explanation, the MBSFN CQI can be interchangeably used with MBMS CQI as the same value.

For an MBSFN CQI calculation, a UE measures a channel with reference to MBSFN RS then calculates a highest MCS satisfying BLER (block error rate) 0.1 from CSI reference resources.

The MBSFN CQI can be defined as follows. Based on an interval observed without limitation on frequency and time, a UE may derive each CQI value reported in an uplink subframe with a highest CQI index among CQI indices 0 to 15 in Table 3 which satisfies the following condition. The condition is that a single PMCH transport block, which is modulation scheme and transport block size corresponding to a CQI index and is a downlink physical resource block for the CSI reference resources, should be received with a transport block error probability not exceeding 0.1. Alternatively, the MBMS CQI is set to CQI index 0 if CQI index 1 does not satisfy the above condition.

TABLE 3

| | | | |
|---|---|---|---|
| CQI index | modulation | code rate × 1024 | efficiency |

| | |
|---|---|
| 0 | out of range |

| | | | |
|---|---|---|---|
| 1 | QPSK | 78 | 0.1523 |
| 2 | QPSK | 120 | 0.2344 |
| 3 | QPSK | 193 | 0.3770 |
| 4 | OPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

An MBMS CSI subframe set for MBMS CSI reference resources may be configured for each MBSFN area by a high layer through RRC signaling.

The MBMS CSI reference resource can be defined as follows. In frequency domain, the MBMS CSI reference resource can be defined as a group of downlink physical resource blocks corresponding to the full channel bandwidth. In time domain, the MBMS CSI reference resource can be defined as one downlink subframe.

A downlink subframe in a serving cell may be considered to be valid if the following conditions are met: (1) it is configured as a downlink subframe for a UE; (2) it is an MBSFN subframe; (3) a UE is configured to decode PMCH through high layer signaling; and (4) it does not fall within a measurement gap configured for a UE.

To derive the MBMS CQI index, a UE can assume the following in the MBMS CSI reference resource. First of all, first 2 OFDM symbols are occupied by control signals. Secondly, it is assumed that there is no resource element allocated for PRS.

The UE calculates the MBSFN CQI for each MBMS reference resource and then saves the calculated MBSFN CQI in a buffer. If it is triggered by a specific condition, the UE reports the saved MBSFN CQI all together to the base station. In this case, as the MBSFN CQI is calculated per MBMS reference resource, battery consumption of the UE increases. And, as the corresponding values are saved until when reporting is triggered, memory consumption of the UE also increases. Moreover, as the amount of MBSFN CQI to be reported to the base station increases, high uplink payload is required. To solve such problems, it is preferred to apply the following methods.

As a first method, in case that a value of a currently calculated MBSFN CQI is equal to that of an immediately previously calculated MBSFN CQI, the UE not only does not save the currently calculated MBSFN CQI in the buffer but also does not report the currently calculated MBSFN CQI. In other words, if the value of the currently calculated MBSFN CQI is different from that of the immediately previously calculated MBSFN CQI, the UE saves the currently calculated MBSFN CQI in the buffer and reports the currently calculated MBSFN CQI.

Alternatively, if difference between the currently calculated MBSFN CQI value and the immediately previously calculated MBSFN CQI value is less than a specific value, delta, the UE does not save the currently calculated MBSFN CQI in the buffer and does not report the currently calculated MBSFN CQI. In particular, if the difference between the currently calculated MBSFN CQI value and the immediately previously calculated MBSFN CQI value is equal to or greater than the specific value, delta, the UE saves the currently calculated MBSFN CQI in the buffer and reports the currently calculated MBSFN CQI. The delta may be indicated to the UE by the base station through RRC signaling and the like or be set to a fixed value.

The UE may inform the base station of CQI-calculated time information by reporting subframe information of a CSI reference resource having the corresponding CQI calculated therein together with the MB SFN CQI.

As a second method, the UE calculates the MBSFN CQI from a CSI reference resource spaced apart more than N subframes from the CSI reference resource of the immediately previously calculated MBSFN CQI and then reports the calculated value. In particular, if the CSI reference resource of the immediately previously calculated MBSFN CQI corresponds to n subframe, the UE restricts a new CSI reference resource to (n+N) subframe or a subframe after the (n+N) subframe. Such conditions may be specified as follows.

In time domain, an MBMS CSI reference resource is set as a single downlink subframe of (n−m). In this case, n is the downlink subframe number by which a MBMS CSI reference resource for last saved MBMS CQI is defined and m is a smallest value equal to or greater than N such that it corresponds to a valid downlink subframe.

In this case, N may be transmitted to the UE by the base station through RRC signaling and the like or be set to a fixed value defined between the base station and the UE.

As a third method, a delta CQI value is used to reduce a payload size of the MBMS CQI.

4 bits MCS table is used for an initial MBMS CQI and MCS level difference with respect to a previous MBMS CQI, i.e., delta CQI is reported for later MBMS CQI.

For instance, 2 bits of delta CQIs 00, 01, 10 and 11 represent MCS level+1, the same MCS level, MCS level−1, and MCS level−2, respectively. In particular, the delta CQI represents variation on the basis of MCS level of the previous MBMS CQI.

To prevent error propagation due to the introduction of the delta CQI, the delta CQI can be applied in a manner of making a bundle of X delta CQIs. In particular, after the MBMS CQI is calculated using 4bits MCS table, the number X of next MBMS CQIs are calculated using the delta CQIs. Thereafter, the MBMS CQI is calculated using 4 bits MCS table again and then X next MBMS CQIs are calculated using the delta CQIs. Accordingly, the error propagation can be minimized.

As a forth method, a UE may use a plurality of MBMS CSI reference resources to calculate a single MBMS CQI.

The conventional CQI is calculated based on one MBMS CSI reference resource corresponding to one subframe. However, if the MBMS CQI is calculated in each MBMS CSI reference resource corresponding to a single subframe as mentioned in the foregoing description, it may cause a large burden in terms of signaling and complexity. Thus, a single MBMS CQI is calculated using a plurality of MBMS CSI reference resources (i.e. M MBMS CSI reference resources) or using a plurality of subframes (i.e., M subframes) as an MBMS CSI reference resource. M may be transmitted to the UE by the base station or be set as a fixed value defined between the base station and the UE.

In case of calculating a single MBMS CQI using a plurality of MBMS CSI reference resources (i.e., M MBMS CSI reference resources), it may be configured as follows.

Based on an interval observed without limitation on frequency and time, a UE may derive each CQI value reported in an uplink subframe with a highest CQI index among CQI indices 0 to 15 in Table 3 which satisfies the following condition. The condition is that a single PMCH transport block, which is modulation scheme and transport block size corresponding to a CQI index and is a downlink physical resource block corresponding to M CSI reference resources, should be received with a transport block error probability not exceeding 0.1. Alternatively, the MBMS CQI is set to CQI index 0 if CQI index 1 does not satisfy the above condition.

Alternatively, different from the method of selecting CQI with BLER not exceeding 0.1 in case of transmitting a single PMCH transport block with respect to a plurality of subframes corresponding to M CSI reference resources, according to the following method, the CQI with BLER not exceeding 0.1 can be selected in case of transmitting a single PMCH transport block with respect to a single random CSI reference resource among M CSI reference resources. In other words, it is configured to satisfy each of the M resources.

Based on an interval observed without limitation on frequency and time, a UE may derive each CQI value reported in an uplink subframe with a highest CQI index among CQI indices 0 to 15 in Table 3 which satisfies the following condition. The condition is that a single PMCH transport block, which is modulation scheme and transport block size corresponding to a CQI index and is a downlink physical resource block corresponding to one of M CSI reference resources, should be received with a transport block error probability not exceeding 0.1. Alternatively, the MBMS CQI is set to CQI index 0 if CQI index 1 does not satisfy the above condition.

In case of calculating a single MBMS CQI using a plurality of subframes (i.e., M subframes), it may be defined as follows.

In frequency domain, the MBMS CSI reference resource can be defined as a group of downlink physical resource blocks corresponding to the full channel bandwidth. In time domain, the MBMS CSI reference resource can be defined as M downlink subframes.

M downlink subframes in a serving cell may be considered to be valid if the following conditions are met: (1) each of the downlink frames is configured as a downlink subframe for a UE; (2) each of the downlink frames is an MBSFN subframe; (3) a UE is configured to decode PMCH through high layer signaling for each of the downlink subframes; and (4) each of the downlink subframes does not fall within a measurement gap configured for a UE.

To derive the MBMS CQI index, a UE can assume the following in each of the M MBMS CSI reference resource. First of all, first 2 OFDM symbols are occupied by control signals. Secondly, it is assumed that there is no resource element allocated for PRS.

According to the aforementioned methods, a UE averages signal power or interference power set for specific frequency time resources. The above-proposed method for determining frequency time resources can be used for a random MBSFN radio metric. If the UE determines a time frequency resource region corresponding to a target to be averaged, the UE may report information on the corresponding resource region together with the MBSFN radio metric to a base station. Moreover, the above-mentioned CQI calculation methods can be utilized not only for MBMS CQI but also for various types of CQIs.

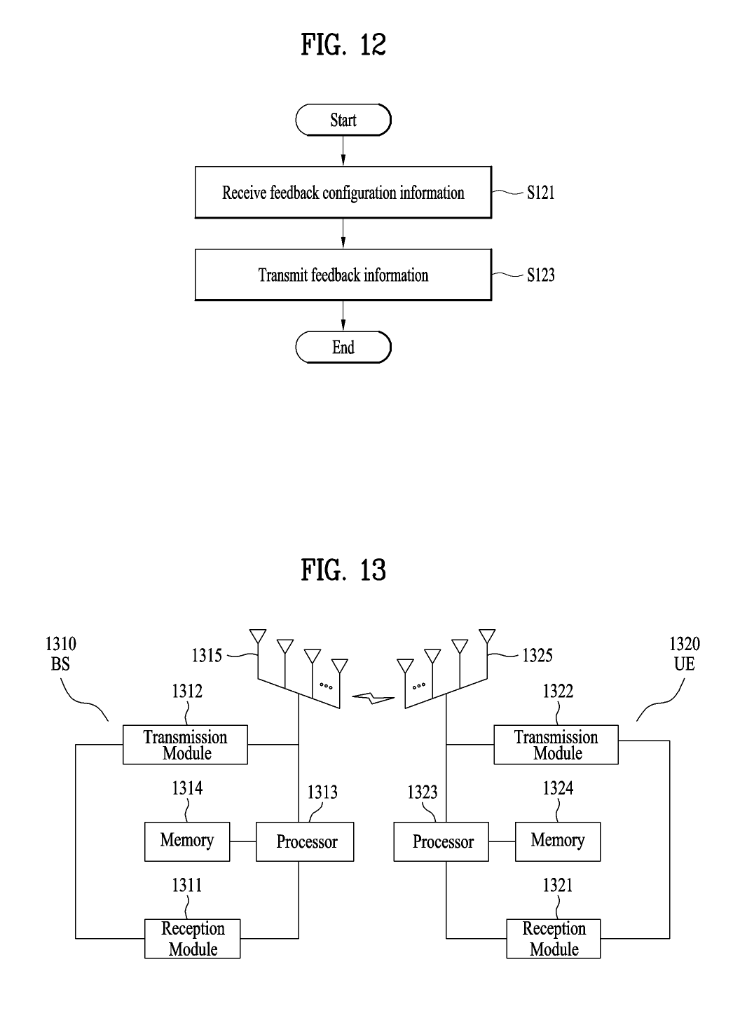

Referring to FIG. 12, a feedback method according to one embodiment of the present invention is described.

In step S121, a user equipment receives configuration information for feedback information. In this case, the configuration information corresponds to information for configuring the feedback method explained in the foregoing description with reference to the embodiments 1 to 7 and its technical features are the same as described above.

In step S123, the user equipment transmits the feedback information measured in a resource region according to the configuration information. The feedback information preferably includes MBSFN CQI and details are the same as the foregoing description explained with reference to the embodiments 1 to 7.

FIG. 13 illustrates examples of a base station and a user equipment applicable to one embodiment of the present invention.

If a relay node is included in a wireless communication system, a communication in backhaul link is performed between a base station and the relay node and a communication in access link is performed between the relay node and a user equipment. Therefore, the base station or user equipment shown in the drawing can be substituted with the relay node in some cases.

Referring to FIG. 13, a wireless communication system includes a base station 1310 and a user equipment 1320. The base station 1310 includes a processor 1313, a memory 1314 and an RF (radio frequency) unit 1311 and 1312. The processor 1313 can be configured to implement the procedures and/or methods proposed by the present invention. The memory 1314 is connected to the processor 1313 and stores various kinds of informations related to operations of the processor 1313. The RF unit 1316 is connected to the processor 1313 and transmits and/or receives radio or wireless signals. The user equipment 1320 includes a processor 1323, a memory 1324 and an RF unit 1321 and 1322. The processor 1323 can be configured to implement the procedures and/or methods proposed by the present invention. The memory 1324 is connected to the processor 1323 and stores various kinds of informations related to operations of the processor 1323. The RF unit 1321 and 1322 is connected to the processor 1323 and transmits and/or receives radio or wireless signals. The base station 1310 and/or the user equipment 1320 can have a single antenna or multiple antennas.

The above-described embodiments may correspond to combinations of elements and features of the present invention in prescribed forms. And, it may be able to consider that the respective elements or features may be selective unless they are explicitly mentioned. Each of the elements or features may be implemented in a form failing to be combined with other elements or features. Moreover, it may be able to implement an embodiment of the present invention by combining elements and/or features together in part. A sequence of operations explained for each embodiment of the present invention may be modified. Some configurations or features of one embodiment may be included in another embodiment or can be substituted for corresponding configurations or features of another embodiment. And, it is apparently understandable that a new embodiment may be configured by combining claims failing to have relation of explicit citation in the appended claims together or may be included as new claims by amendment after filing an application.

In this disclosure, a specific operation explained as performed by a base station may be performed by an upper node of the base station in some cases. In particular, in a network constructed with a plurality of network nodes including a base station, it is apparent that various operations performed for communication with a terminal can be performed by a base station or other networks except the base station. ‘Base station (BS)’ may be substituted with such a terminology as a fixed station, a Node B, an eNode B (eNB), an access point (AP) and the like.

Embodiments of the present invention may be implemented using various means. For instance, embodiments of the present invention may be implemented using hardware, firmware, software and/or any combinations thereof. In case of the implementation by hardware, one embodiment of the present invention may be implemented by at least one of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, one embodiment of the present invention may be implemented by modules, procedures, and/or functions for performing the above-explained functions or operations. Software code may be stored in a memory unit and may be then drivable by a processor.

The memory unit may be provided within or outside the processor to exchange data with the processor through the various means known to the public.

As mentioned in the foregoing description, the detailed descriptions for the preferred embodiments of the present invention are provided to be implemented by those skilled in the art. While the present invention has been described and illustrated herein with reference to the preferred embodiments thereof, it will be apparent to those skilled in the art that various modifications and variations can be made therein without departing from the spirit and scope of the invention. For instance, the respective configurations disclosed in the aforementioned embodiments of the present invention can be used by those skilled in the art in a manner of being combined with each other. Therefore, the present invention is non-limited by the embodiments disclosed herein but intends to give a broadest scope that matches the principles and new features disclosed herein.

It will be apparent to those skilled in the art that the present invention may be embodied in other specific forms without departing from the spirit and essential characteristics of the invention. Thus, the above embodiments should be considered in all respects as exemplary and not restrictive. The scope of the present invention should be determined by reasonable interpretation of the appended claims and the present invention covers the modifications and variations of this invention that come within the scope of the appended claims and their equivalents. The present invention is non-limited by the embodiments disclosed herein but intends to give a broadest scope that matches the principles and new features disclosed herein. And, it is apparently understandable that an embodiment is configured by combining claims failing to have relation of explicit citation in the appended claims together or can be included as new claims by amendment after filing an application.

### INDUSTRIAL APPLICABILITY

The present invention can be applied to various wireless communication devices including a user equipment, a relay, a base station and the like.

What is claimed is:

1. A method for reporting feedback information of MBSFN (multicast broadcast multimedia services) transmission by a user equipment in a wireless communication system, the method comprising the steps of:
receiving configuration information for the feedback information of the MBSFN transmission; and
transmitting the feedback information measured in a resource region according to the configuration information,
wherein the feedback information comprises one MBSFN CQI (channel quality indicator) generated based on M (M≧2) MBSFN CSI (channel state information) reference resources.

2. The method of claim 1, wherein the MBSFN CQI is calculated based on whether a transport block error probability with respect to each resource included in the M MBSFN CSI reference resources is equal to or less than a reference.

3. The method of claim 1, wherein the MBSFN CQI is calculated on an assumption that control signals are transmitted in first 2 symbols of M downlink subframes corresponding to the M MBSFN CSI reference resources and there is no resource element allocated for a PRS (positioning reference signal).

4. The method of claim 1, wherein the MBSFN CQI is reported if a difference value between the MBSFN CQI and a previously calculated MBSFN CQI is equal to or greater than a reference value.

5. The method of claim 1, wherein the MBSFN CQI is calculated in a subframe spaced apart more than a prescribed number of subframes from an MBSFN CSI reference resource of an immediately previously reported MBSFN CQI.

6. The method of claim 1, wherein the MBSFN CQI is configured to indicate a difference value between the MBSFN CQI and an immediately previously reported MBSFN CQI.

7. The method of claim 1, wherein information on the M is received from a base station through RRC (radio resource control) signaling.

8. A user equipment for reporting feedback information of MBSFN (multicast broadcast multimedia services) transmission in a wireless communication system, the user equipment comprising:
an RF (radio frequency) unit; and
a processor,
wherein the processor is configured:
to receive configuration information for the feedback information of the MBSFN transmission, and
to transmit the feedback information measured in a resource region according to the configuration information, and
wherein the feedback information comprises one MBSFN CQI (channel quality indicator) generated based on M (M≧2) MBSFN CSI (channel state information) reference resources.

9. The user equipment of claim 8, wherein the MBSFN CQI is calculated based on whether a transport block error probability with respect to each resource included in the M MBSFN CSI reference resources is equal to or less than a reference.

10. The user equipment of claim 8, wherein the MBSFN CQI is calculated on an assumption that control signals are transmitted in first 2 symbols of M downlink subframes corresponding to the M MBSFN CSI reference resources and there is no resource element allocated for a PRS (positioning reference signal).

11. The user equipment of claim 8, wherein the MBSFN CQI is reported if a difference value between the MBSFN CQI and a previously calculated MBSFN CQI is equal to or greater than a reference value.

12. The user equipment of claim 8, wherein the MBSFN CQI is calculated in a subframe spaced apart more than a prescribed number of subframes from an MBSFN CSI reference resource of an immediately previously reported MBSFN CQI.

13. The user equipment of claim 8, wherein the MBSFN CQI is configured to indicate a difference value between the MBSFN CQI and an immediately previously reported MBSFN CQI.

14. The user equipment of claim 8, wherein information on the M is received from a base station through RRC (radio resource control) signaling.
